(19) United States
(12) Patent Application Publication
(10) Pub. No.: US 2005/0289358 A1
(43) Pub. Date: Dec. 29, 2005

(54) Method and system for sensitive information protection in structured documents

(75) Inventors: J. Kirk Haselden, Issaquah, WA (US); Sergei Ivanov, Issaquah, WA (US)

Correspondence Address: WOODCOCK WASHBURN LLP (MICROSOFT CORPORATION), ONE LIBERTY PLACE - 46TH FLOOR, PHILADELPHIA, PA, 19103, US

(73) Assignee: Microsoft Corporation, Redmond, WA (US)

(21) Appl. No.: 10/879,425

(22) Filed: Jun. 29, 2004

(51) Int. Cl. G06F 11/30

(52) U.S. Cl. 713/187

(57) ABSTRACT

A method to protect elements of an extensible object placed within a structured document includes identifying marked elements of the object where both the element and the type of protection is indicated. The elements to be protected are processed according to the level of protection indicated by the protection marker. The element is returned to the object, the object is returned to the structured document, and the protected structured document is made available. The reverse process involves removal of the protection from appropriately marked elements of an object in a structured document. The protected document is loaded and the protection markers are read. The protection on the elements is removed and the elements are restored to the objects. The structured document having restored objects and elements is now available in the clear. A system performing the methods includes a graphical user interface which allows the user to orchestrate the processes.

### FIELD OF THE INVENTION

This invention relates in general to the field of information protection. More particularly, this invention relates to protection of data elements in structured documents.

### BACKGROUND OF THE INVENTION

The protection of software packages, such as computer files containing structured documents, has presented access problems if key information is lost. For example, FIG. 1 is a typical software package 100 that contains multiple tasks 105, 110, and 115. If protection of the software package is desired, generally the entire package is protected. However, if the entire package 100 is protected via encryption, and the decryption key is lost, then the entire package is rendered inaccessible. This basic approach follows by lesser levels of protection as well. If software package 100 is password protected, then the entire package is inaccessible if the password is lost.

Another method of protection may be to protect segments of the software package such that loss of a key or password results in the loss of only a portion of the package. For example, if task two, 110, of FIG. 1, is password protected, the loss or inoperability of the password results in only the loss of the particular task. Broadening this concept, if the tasks of FIG. 1 were software objects, then the loss of a particular object due to inoperability or loss of a key or password results in only loss of the particular object. This is more desirable than loss of the entire software package.

Additionally, there may be a desire to protect only some of the data within a software package. Also, if there are multiple third party objects within a software package, each may wish to protect elements within the objects at differing levels of protection, such as encryption, password access control, or digital signature. However, current methods do not allow the selective protection of objects within a software package such as, for example, a structured document.

Additionally, in the software environment of a structured document, it is desirable to permit each component of the document to advertise what parts of the data are critical and require protection, and to indicate what degree of protection may be used.

Thus, there is a need for a mechanism that would grant providers of components of structured documents the ability to declare sensitivity levels of data elements found in that component's segment of structured document file. The present invention addresses the aforementioned needs and prescribes an architecture for solving them with additional advantages as expressed herein.

### SUMMARY OF THE INVENTION

An embodiment of the invention includes a method to protect data elements of an extensible object placed within a structured document. The method includes identifying sensitivity levels of data elements by marking them in a certain way. The elements found to be sensitive are then processed according to the level of protection indicated by the user. The processed data element is replaced into structured document and can be made available to a user for further use or storage to non-secure device.

Another embodiment of the invention includes a method of removing the protection from data elements in a structured document. The method involves loading the protected document and reading the protection markers. The protection markers indicating what elements were protected and in what fashion. The method includes removing the protection from the marked elements and replacing unprotected data back into the structured document. The unprotected document may now be used for secure in-memory operations.

A system comprises first means for generating a protected structured document where objects in structured document contain elements marked as protected elements. The system also includes second means for un-protecting the elements of the objects subject to protection. The result of the first means is to produce a protected structured document. The result of the second means is to produce a structured document where the objects are in the clear and may be used directly. In one embodiment, the system includes a graphical user interface which allows a user to orchestrate the first and second means.

### BRIEF DESCRIPTION OF THE DRAWINGS

The foregoing summary, as well as the following detailed description of preferred embodiments, is better understood when read in conjunction with the appended drawings. For the purpose of illustrating embodiments of the invention, there is shown in the drawings exemplary constructions of the invention; however, the invention is not limited to the specific methods and instrumentalities disclosed. In the drawings:

FIG. 1 is a block diagram of an exemplary software package;

FIG. 2 is diagram of an aspect of the invention;

FIG. 3 is a exemplary flow diagram of an embodiment of the invention;

FIG. 4 is a block diagram of an embodiment of the invention;

FIG. 5 is a block diagram of another embodiment of the invention;

FIG. 6 is a block diagram showing an exemplary computing environment in which aspects of the invention may be implemented.

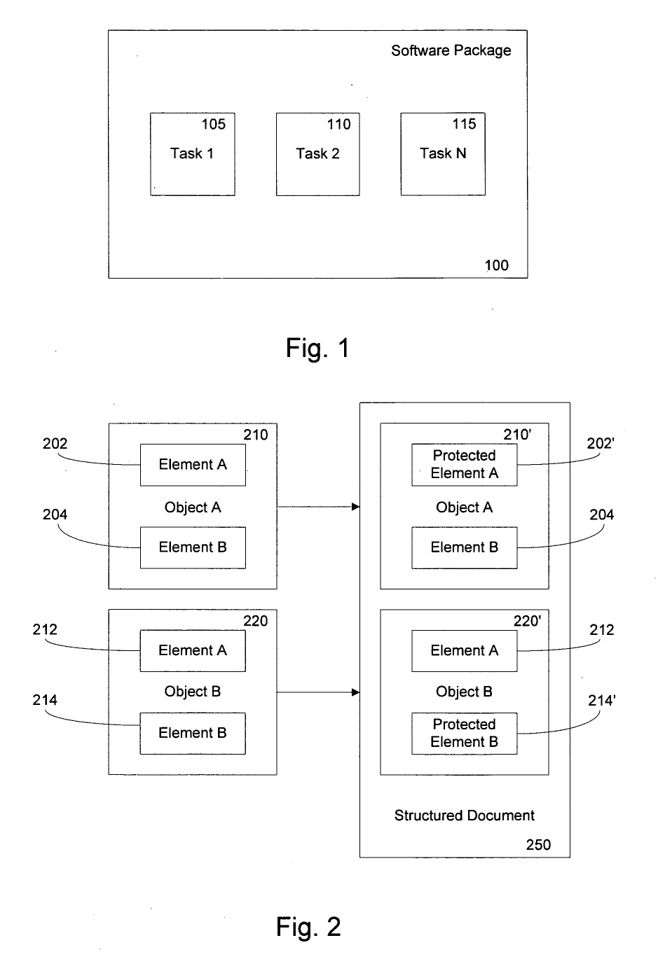

### DETAILED DESCRIPTION OF ILLUSTRATIVE EMBODIMENTS

Overview

An embodiment of the invention provides a mechanism allowing extensible structured documents, such as a Data Transformation Services (DTS™ is available from Microsoft corporation of Redmond, Wash.) workflow package, to contain information of different levels of sensitivity. The user is allowed to select protection methods for each level of sensitivity. An example of a structured document is an XML document. In the embodiment, a structured document contains third-party plug-in objects that are unknown at the time the document handling system is designed. Objects contain both the data (attributes) and the processing (methods) to allow one object to interact with another object to achieve the goals of a software package in which it is contained. In one embodiment, third party objects can declare a sensitivity level concerning elements of information within the object. A document manager can provide configurable protection methods for that sensitive information. As a result, sophisticated information protection mechanisms become available to third-party objects.

The software package containing the protected elements and objects can be stored on a server with reasonable safety from unauthorized use because of the protection mechanisms provided to the objects by the document manager. When accessed by authorized user, the protected information is placed in the clear in-memory so that the software package may be executed and so that the user may gain access to the software package to exercise its utility.

Exemplary Embodiments of the Invention

One approach to addressing the protection of third party objects is to embed third party objects into a structured document and then selectively protect the third party objects. FIG. 2 depicts multiple objects 210 and 220 each having elements which can be left in the clear or protected if integrated into a structured document. For example, it may be desirable to protect element A, 202, of object A, 210. It may also be desirable to protect element B, 214, of object B, 220. As an aspect of the invention, structured document 250 may contain the protected elements 202′ and 214′ of objects 210′ and 220′ respectively. Structured document 250 can be stored, for example, on a server, such that it is resistant to improper use because of the protection of various elements of the objects which the structured document contains.

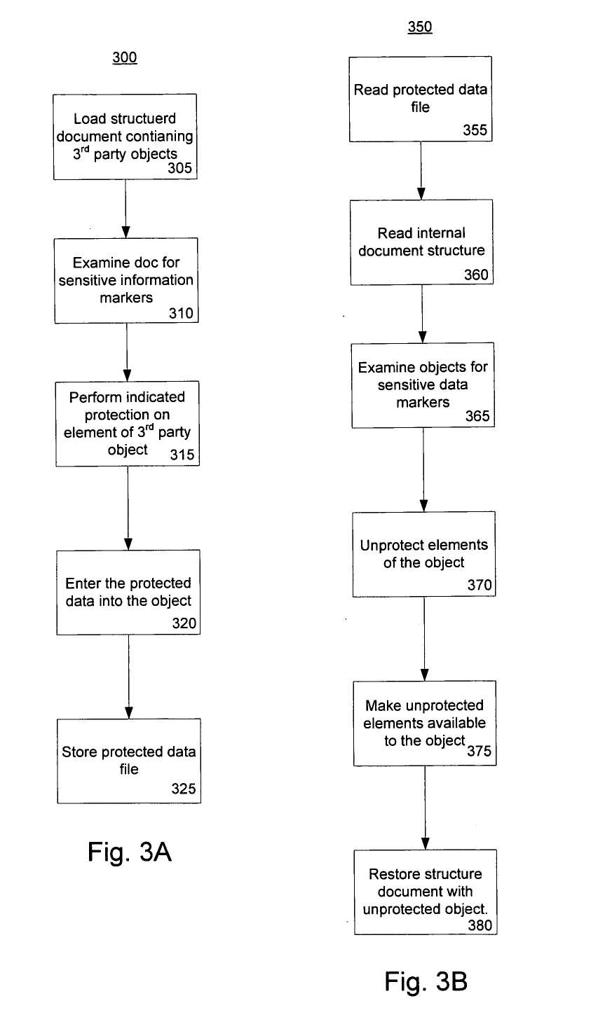

FIG. 3A depicts a flow diagram 300 for an embodiment including a structured document with protected objects. In one embodiment, the software package containing one or more objects can be a structured document, such as an XML document. In the present embodiment, it may be assumed that a third party object is available that will reside in the organization of the structured document and that there are elements of the object which are sensitive information.

Sensitive information may be information that the third part object considers confidential or that is in need of protection. Examples of such information are passwords, encryption or decryption keys, account numbers, or client identity information that is desirably masked from unauthorized users of the object. Such information can be protected using aspects of the invention without the risk of loosing the entire structured document if the key(s) eventually become(s) inaccessible. This approach allows a partial recovery of the software package if an object is lost. In the present embodiment, it is assumed that elements of the object contained in the software package are marked as being sensitive information. The sensitive information marker can identify a level of protection such as, for example, encryption, digital signature, encryption and signature, and complete suppression of sensitive data.

An exemplary process of generating a protected file is depicted in FIG. 3A. The exemplary process of FIG. 3A begins with loading (step 305) a structured document that contains third party objects. As expressed above, the document may be an XML format, although other formats are possible. The structured nature of the document allows the examination of the internal organization or structure of the document and allows the recognition of the third party objects.

The third party objects are examined for sensitive information markers (step 310). These markers are placed into the document by either the third party object generator or the structured document generator to specifically mark information (a data element of the object) that is deemed to be sensitive. In addition to the markers themselves, the markers associate a level of protection that is desired with respect to the sensitive information. Step 315 applies the level of protection indicated by the marker concerning an element of the third party object.

The protected element is then replaced into the structure of the third party object (step 320). This step produces an object that has protected elements; the protection being the level specified by the sensitive information markers. The object can be returned into the structured document. The document thus generated now has protected elements in specific objects within the organization of the structured document. The structured document may now be placed into storage as a protected data file (step 325).

If the protected data file is to be used, it may be accessed via the method of FIG. 3B. The method 350 begins by reading the protected file (step 355) generated with the process of FIG. 3A. As before the internal structure of the structured document is read (step 360) to discover third party objects embedded within the organization of the structured document. The objects are extracted and examined for sensitive data markers (step 365) which now indicate the presence of protected information. The sensitive data markers are associated with a specific level of protection that the data element within the object retains. Knowing which object is protected and the level (or type) of protection, it is now possible to remove the protection (step 370) and expose the element in cleartext.

The unprotected element may then be replaced into the object such that the object is restored to its clear state. Alternately, the now exposed element may be made available to the object such that the object itself, if it is an executable, may subsume the exposed element for re-integration into the object. In either event, the unprotected element is made available to the third party object (step 375). Finally, the now restored third party object may be returned to the organization of the structured document (step 380) such that the clear structured document, with fully functional third party objects is made available to an application that desires to gain access to the functionality of the structured document.

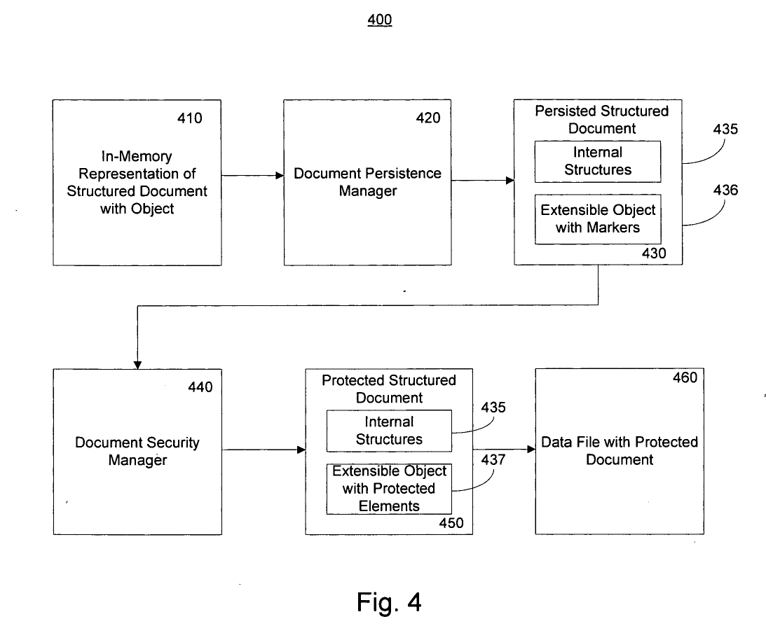

FIG. 4 is a block diagram of a system, 400, which makes advantageous use of the method of FIG. 3A. Initially, an in-memory representation if a structured document with an object 410 is made available to a document persistence manager 420. The structured document may be an XML or other structured language document with embedded objects. In this exemplary embodiment of FIG. 4, an object model environment may be present. For example, a document object model (DOM) or structured query language management object (SMO) environment may be present. The DOM environment allows application program interfaces (APIs) access to programs and scripts to control aspects of HTML and XML style documents. The SMO environment is the management model object for SQL Server™ available from Microsoft Corporation of Redmond, Wash. A SMO environment allows the use of APIs to access and control aspects of database management applications.

One aspect of the FIG. 4 environment is that the environment allows the use of extensible objects. Extensible objects derive their extensibility via the APIs that may be used to introduce new behaviors in the system though use of third party objects. In this exemplary configuration, the extensibility is the identification, using markers, of the sensitive information (or elements) within the third party objects. The extensibility allows a definition of a protocol which can assist in identification of the sensitive information.

The sensitive information may be found in any of the objects of the structured document. Each object may be representative of tasks that may be performed with the structured document. The sensitive information can be an identified with markers in a structured language having an attribute which indicates the level of protection that is desired for the sensitive information. For example, the following code is indicative of a sensitive information marker and protection level of an element, a password, of an object in the structured document.
<FTP Server> FTP ms.com </FTP Server>
<Password Sensitivity=Encrypt> #13188</Password>

In the above example, the object element is the password and the marker is the password sensitivity statement along with the protection level, which in this instance is the level of encryption. As an example, the marker could be of the format <tag attribute=value>.

The document persistence manager 420 of FIG. 4 reads the in-memory representation of the structured document and determines, from the structure and markers, where the third party objects are located. The document persistence manager can read the organization of the structured document 430, identify the internal structures 435, and identify the extensible objects.

The persisted structure of the document is passed to a document security manager 440 where the objects are examined to find the elements of the objects that are marked as sensitive information. Once found, the markers may be read to determine what level of protection is to be applied to the element of the object. The document security manager applies the level of security indicated to the element to produce a protected element. The resulting element may be of the form:
<Password Sensitivity=Encrypt Encrypted=“1”> #XXXX</Password>
   Where the element of the data has been encrypted and is now represented by XXXXX. The protected element may then be made available to the object from which it came.

Once the protected element is re-integrated into the object, the document security manager 440 can produce a protected form 450 of the structured document which includes the same original internal structure 435 having the extensible objects with the now protected elements 437 integrated into the document organization. The protected structured document may then be stored as a data file.

In one embodiment, the data file may reside on a server where the protected structured document is made available for use. Authorized users, who have access to the proper decoding scheme equipment described below, may gain access to the structured document and its protected contents. Unauthorized users, even if they gain access to the protected form of the structured document, will be unable to execute the functionality of the protected structured document methods because sensitive information is protected from inadvertent exposure.

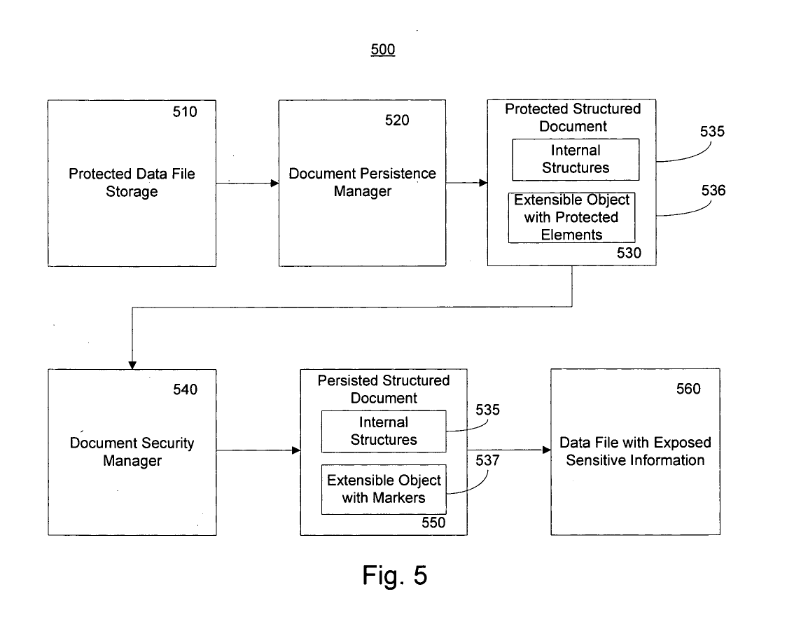

FIG. 5 is a depiction of an embodiment of the invention 500 that allows access to the protected structured document. The protected data file 510 can be input into a document persistence manager 520 when access to a clear version of the protected structured document is needed. The document persistence manager 520 accepts the protected document and detects its structured organization. The protected structured document 530 may be determined to include internal structures 535 as well as extensible objects with protected elements 536. Once detected, the third party objects may be tested for protected elements.

Once protected elements are found, they may be forwarded to the document security manager 540 which reads the markers used to identify the protected elements. The document security manager 540 also determines the protection level or type and can proceed to unprotect the element using the appropriate mechanism. For example, if a password was encrypted as part of a protection level, the document security manager un-encrypts the element using a compatible algorithm. If the protected element was protected using a digital signature, the signature is verified so as to verify the source of the element, object, or document as genuine.

Once the protected element is returned to a clear state, it is made available to the object from which it came. In one embodiment, this may mean that the object is free to include the element as part of the objects organization. In another embodiment, the available and clear element is placed back into the object. In either event, the now clear object is made available to the structured document. The structured document 550 then includes its internal structures 535 and the extensible object with markers 537. The previously protected data file 510 is thus available in clear form as a data file with exposed sensitive information 560.

The exposed sensitive information in the structured document may now be made available to a user or program that requires the functionality of the structured document with embedded objects. Note that after the file is used, it may be returned to the its protected data form by using the embodiment of FIG. 4 which is an embodiment of the method of FIG. 3A. The protected form of the structured document may then be safely stored, for example in a server, until required again at some later time.

In one embodiment, the functions of FIGS. 4 and 5 may be combined into a single Data Transformation Services (DTS) system. Such a system may operate on workflow packages. To simplify operations, a user interface may be employed which allows a user to graphically create or manipulate documents, objects, and elements to make a protected structured document as in item 460 of FIG. 4.

The user can assemble objects transferred from third party sources that can be used in the generation of structured documents. The user can classify information as sensitive or can use pre-existing sensitive information markers in third party objects. The pre-existing or newly tagged sensitive information can be used to create a structured document that contain extensible objects with elements of differing sensitivity. Alternately, the user can input such a structured document into the DTS. In either event, the user may protect the structured document according to the markers and protection levels indicated on elements within the third party objects; thereby creating a file containing a protected structured document. The protected file may then be moved or used wherever needed.

The DTS may also be used to unprotect the protected structured document via a graphical interface which allows the user to monitor the progress, if not control the procedure applied to the protected document to render it into a clear form. Using this method may involve the use of the method of FIG. 3B and a system according to FIG. 5. In either case, the DTS system may include both the protection and unprotecting process methods coupled to a graphical user interface.

Exemplary Computing Device

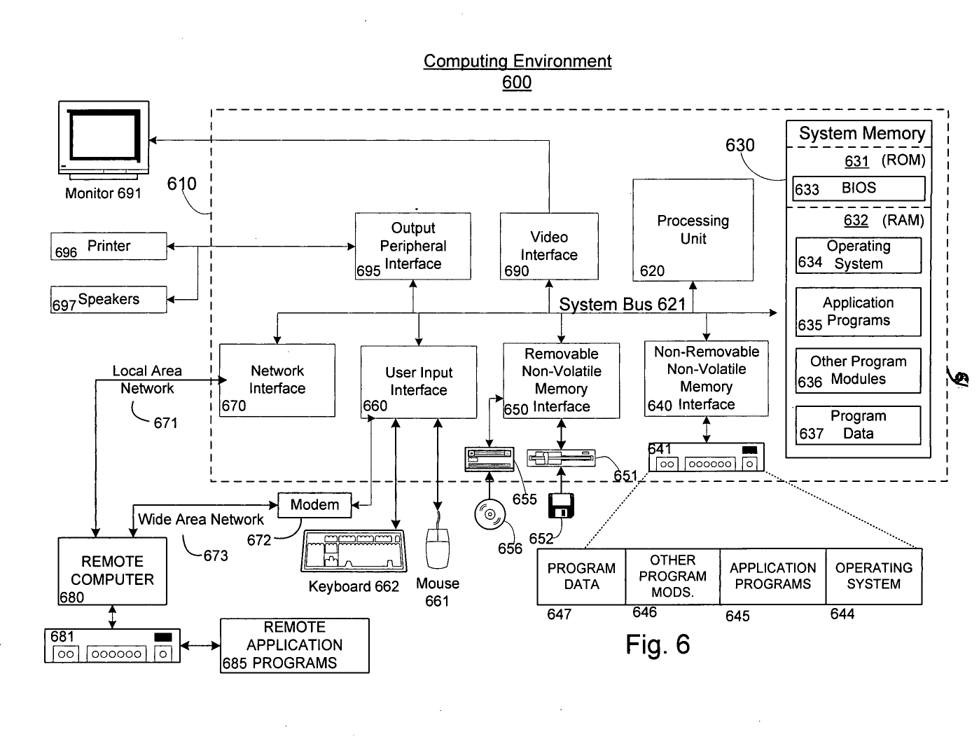

FIG. 6 and the following discussion are intended to provide a brief general description of a suitable computing environment in which embodiments of the invention may be implemented. While a general purpose computer is described below, this is but one example, and embodiments of the invention may be implemented with other computing devices, such as a client having network/bus interoperability and interaction. Thus, embodiments of the invention may be implemented in an environment of networked hosted services in which very little or minimal client resources are implicated, e.g., a networked environment in which the client device serves merely as an interface to the network/bus, such as an object placed in an appliance, or other computing devices and objects as well. In essence, anywhere that data may be stored or from which data may be retrieved is a desirable, or suitable, environment for operation.

Although not required, embodiments of the invention can also be implemented via an operating system, for use by a developer of services for a device or object, and/or included within application software. Software may be described in the general context of computer-executable instructions, such as program modules, being executed by one or more computers, such as client workstations, servers or other devices. Generally, program modules include routines, programs, objects, components, data structures and the like that perform particular tasks or implement particular abstract data types. Typically, the functionality of the program modules may be combined or distributed as desired in various embodiments. Moreover, those skilled in the art will appreciate that various embodiments of the invention may be practiced with other computer configurations. Other well known computing systems, environments, and/or configurations that may be suitable for use include, but are not limited to, personal computers (PCs), automated teller machines, server computers, hand-held or laptop devices, multi-processor systems, microprocessor-based systems, programmable consumer electronics, network PCs, appliances, lights, environmental control elements, minicomputers, mainframe computers and the like. Embodiments of the invention may also be practiced in distributed computing environments where tasks are performed by remote processing devices that are linked through a communications network/bus or other data transmission medium. In a distributed computing environment, program modules may be located in both local and remote computer storage media including memory storage devices and client nodes may in turn behave as server nodes.

FIG. 6 thus illustrates an example of a suitable computing system environment 600 in which the embodiments of the invention may be implemented, although as made clear above, the computing system environment 600 is only one example of a suitable computing environment and is not intended to suggest any limitation as to the scope of use or functionality of an embodiment of the invention. Neither should the computing environment 600 be interpreted as having any dependency or requirement relating to any one or combination of components illustrated in the exemplary operating environment 600.

With reference to FIG. 6, an exemplary system for implementing an embodiment of the invention includes a general purpose computing device in the form of a computer system 610. Components of computer system 610 may include, but are not limited to, a processing unit 620, a system memory 630, and a system bus 621 that couples various system components including the system memory to the processing unit 620. The system bus 621 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer system 610 typically includes a variety of computer readable media. Computer readable media can be any available media that can be accessed by computer system 610 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, Random Access Memory (RAM), Read Only Memory (ROM), Electrically Erasable Programmable Read Only Memory (EEPROM), flash memory or other memory technology, Compact Disk Read Only Memory (CDROM), compact disc-rewritable (CDRW), digital versatile disks (DVD) or other optical disk storage, magnetic cassettes, magnetic tape, magnetic disk storage or other magnetic storage devices, or any other medium which can be used to store the desired information and which can accessed by computer system 610. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 630 includes computer storage media in the form of volatile and/or nonvolatile memory such as read only memory (ROM) 631 and random access memory (RAM) 632. A basic input/output system 633 (BIOS), containing the basic routines that help to transfer information between elements within computer system 610, such as during start-up, is typically stored in ROM 631. RAM 632 typically contains data and/or program modules that are immediately accessible to and/or presently being operated on by processing unit 620. By way of example, and not limitation, FIG. 6 illustrates operating system 634, application programs 635, other program modules 636, and program data 637.

The computer system 610 may also include other removable/non-removable, volatile/nonvolatile computer storage media. By way of example only, FIG. 6 illustrates a hard disk drive 641 that reads from or writes to non-removable, nonvolatile magnetic media, a magnetic disk drive 651 that reads from or writes to a removable, nonvolatile magnetic disk 652, and an optical disk drive 655 that reads from or writes to a removable, nonvolatile optical disk 656, such as a CD ROM, CDRW, DVD, or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 641 is typically connected to the system bus 621 through a non-removable memory interface such as interface 640, and magnetic disk drive 651 and optical disk drive 655 are typically connected to the system bus 621 by a removable memory interface, such as interface 650.

The drives and their associated computer storage media discussed above and illustrated in FIG. 6 provide storage of computer readable instructions, data structures, program modules and other data for the computer system 610. In FIG. 6, for example, hard disk drive 641 is illustrated as storing operating system 644, application programs 645, other program modules 646, and program data 647. Note that these components can either be the same as or different from operating system 634, application programs 635, other program modules 636, and program data 637. Operating system 644, application programs 645, other program modules 646, and program data 647 are given different numbers here to illustrate that, at a minimum, they are different copies. A user may enter commands and information into the computer system 610 through input devices such as a keyboard 662 and pointing device 661, commonly referred to as a mouse, trackball or touch pad. Other input devices (not shown) may include a microphone, joystick, game pad, satellite dish, scanner, or the like. These and other input devices are often connected to the processing unit 620 through a user input interface 660 that is coupled to the system bus 621, but may be connected by other interface and bus structures, such as a parallel port, game port or a universal serial bus (USB). A monitor 691 or other type of display device is also connected to the system bus 621 via an interface, such as a video interface 690, which may in turn communicate with video memory (not shown). In addition to monitor 691, computer systems may also include other peripheral output devices such as speakers 697 and printer 696, which may be connected through an output peripheral interface 695.

The computer system 610 may operate in a networked or distributed environment using logical connections to one or more remote computers, such as a remote computer 680. The remote computer 680 may be a personal computer, a server, a router, a network PC, a peer device or other common network node, and typically includes many or all of the elements described above relative to the computer system 610, although only a memory storage device 681 has been illustrated in FIG. 6. The logical connections depicted in FIG. 6 include a local area network (LAN) 671 and a wide area network (WAN) 673, but may also include other networks/buses. Such networking environments are commonplace in homes, offices, enterprise-wide computer networks, intranets and the Internet.

When used in a LAN networking environment, the computer system 610 is connected to the LAN 671 through a network interface or adapter 670. When used in a WAN networking environment, the computer system 610 typically includes a modem 672 or other means for establishing communications over the WAN 673, such as the Internet. The modem 672, which may be internal or external, may be connected to the system bus 621 via the user input interface 660, or other appropriate mechanism. In a networked environment, program modules depicted relative to the computer system 610, or portions thereof, may be stored in the remote memory storage device. By way of example, and not limitation, FIG. 6 illustrates remote application programs 685 as residing on memory device 681. It will be appreciated that the network connections shown are exemplary and other means of establishing a communications link between the computers may be used.

Various distributed computing frameworks have been and are being developed in light of the convergence of personal computing and the Internet. Individuals and business users alike are provided with a seamlessly interoperable and Web-enabled interface for applications and computing devices, making computing activities increasingly Web browser or network-oriented.

For example, MICROSOFT®'s .NET™ platform, available from Microsoft Corporation, includes servers, building-block services, such as Web-based data storage, and downloadable device software. While exemplary embodiments herein are described in connection with software residing on a computing device, one or more portions of an embodiment of the invention may also be implemented via an operating system, application programming interface (API) or a “middle man” object between any of a coprocessor, a display device and a requesting object, such that operation may be performed by, supported in or accessed via all of .NET™'s languages and services, and in other distributed computing frameworks as well.

As mentioned above, while exemplary embodiments of the invention have been described in connection with various computing devices and network architectures, the underlying concepts may be applied to any computing device or system in which it is desirable to implement a method to protect structured documents having extensible objects. Thus, the methods and systems described in connection with embodiments of the present invention may be applied to a variety of applications and devices. While exemplary programming languages, names and examples are chosen herein as representative of various choices, these languages, names and examples are not intended to be limiting. One of ordinary skill in the art will appreciate that there are numerous ways of providing object code that achieves the same, similar or equivalent systems and methods achieved by embodiments of the invention.

The various techniques described herein may be implemented in connection with hardware or software or, where appropriate, with a combination of both. Thus, the methods and apparatus of the invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device will generally include a processor, a storage medium readable by the processor (including volatile and non-volatile memory and/or storage elements), at least one input device, and at least one output device. One or more programs that may utilize the signal processing services of an embodiment of the present invention, e.g., through the use of a data processing API or the like, are preferably implemented in a high level procedural or object oriented programming language to communicate with a computer. However, the program(s) can be implemented in assembly or machine language, if desired. In any case, the language may be a compiled or interpreted language, and combined with hardware implementations.

While aspects of the present invention has been described in connection with the preferred embodiments of the various figures, it is to be understood that other similar embodiments may be used or modifications and additions may be made to the described embodiment for performing the same function of the present invention without deviating therefrom. Furthermore, it should be emphasized that a variety of computer platforms, including handheld device operating systems and other application specific operating systems are contemplated, especially as the number of wireless networked devices continues to proliferate. Therefore, the claimed invention should not be limited to any single embodiment, but rather should be construed in breadth and scope in accordance with the appended claims.

1. A method to selectively protect software packages containing sensitive information, the method comprising:
receiving a file having a structured document, the structured document containing an object;
identifying at least one selected block of data within the object as sensitive information;
labeling the sensitive information using a protection level marker; and
creating an in-memory representation of a protected file, wherein the sensitive information is protected according to a level specified by the protection level marker.

2. The method of claim 1, wherein receiving a file comprises receiving a file having an XML document containing a third party object.

3. The method of claim 1, wherein labeling the sensitive information comprises using a protection level marker having one of an encrypt, sign, encrypt and sign, and suppress label.

4. The method of claim 1, wherein creating an in-memory representation of a protected file further comprises reading the structured document, object, selected block of data and protection level marker and constructing a protected file.

5. The method of claim 1, wherein creating an in-memory representation comprises:
detecting and saving internal structures of the structured document;
reading and saving the object in a block of data within the internal structures;
examining the object for a protection level marker, wherein the protection level marker identifies elements of the object that are to be protected;
protecting the identified elements of the object; and
storing the protected elements of the object into the internal structure of the structured document.

6. A method of accessing an in-memory representation of a protected file, the method comprising:
loading a protected file having a structured document, the structured document containing an object;
reading internal structures of the structured document;
reading and examining the object for sensitive information markers;
stripping protection from an element of the object if sensitive information markers are present; the stripping producing clear information; and
making the clear information available to the object.

7. The method of claim 6, wherein reading internal structures of the structured document comprises reading structures in an XML document.

8. The method of claim 6, wherein stripping protection from an element of the object comprises performing one or more of un-encryption, un-signing and un-suppressing information in a protected element.

9. The method of claim 6, wherein making the clear information available to the object comprises providing clear information elements to an instance of an object.

10. A system for protecting information in an object, the system comprising:
a processor having access to memory, the memory having instructions which, when executed, perform the method comprising:
receiving a file having a structured document, the structured document containing an object, the object having at least one element associated with a protection level marker for identifying sensitive information;
detecting and saving internal structures of the structured document;
examining the object for the protection level marker;
protecting the at least one marked element of the object; and
storing the protected elements of the object into an internal structure of the structured document.

11. A system for extracting protected information, the system comprising:
a processor having access to memory, the memory having instructions which, when executed, perform the method comprising:
loading a protected file having a structured document, the structured document containing an object, the object having protected elements;
reading and examining the object for sensitive information markers;
removing protection from an element of the object if sensitive information markers are present, wherein the removing produces clear information; and
including the clear information into the object.

12. A computer-readable medium having computer-executable instructions for performing a method, the method comprising:
receiving a file having a structured document, the structured document containing an object, the object having at least one element associated with a protection level marker for identifying sensitive information;
examining the object for the protection level marker;
protecting the at least one marked element of the object; and
storing the protected elements of the object into an internal structure of the structured document.

13. A computer-readable medium having computer-executable instructions for performing a method, the method comprising:
loading a protected file having a structured document, the structured document containing an object, the object containing a protected portion;
examining the object for sensitive information markers;
removing protection from the protected portion to produce a unprotected portion if sensitive information markers are present.

14. A computer system for performing data transformations, the system comprising:
a processor having access to memory, the memory having instructions which, the instructions having:
means for providing protection of elements of objects within structured documents;
means for removing protection from elements of objects within structured documents; and
a user interface, the user interface enabling control of at least one of the selection and protection of elements of objects, the generation of a protected file, the storage of a protected file, the removal of protection from elements of an object within a structured document.

15. The system of claim 14, wherein the structured documents are XML documents.

16. The system of claim 14, wherein the objects are third party extensible objects.
